(19) United States
(12) Patent Application Publication
(10) Pub. No.: US 2006/0130870 A1
(43) Pub. Date: Jun. 22, 2006

(54) Method for sonic cleaning of reactor with reduced acoustic wave cancellation

(76) Inventors: Ping Cai, Hurricane, WV (US); William A. Matthews, Victoria, TX (US)

Correspondence Address: Univation Technologies LLC;Suite 1950, 5555 San Felipe St., Houston, TX, 77056, US

(21) Appl. No.: 11/247,372

(22) Filed: Oct. 11, 2005

Related U.S. Application Data
(60) Provisional application No. 60/637,932, filed on Dec. 21, 2004.

(51) Int. Cl. B08B 3/12; B08B 9/00

(52) U.S. Cl. 134/1; 134/22.1

(57) ABSTRACT

In some embodiments, a method for sonically cleaning a reactor (for example, a fluidized bed reactor useful for the production of polyolefins) using a set of sonic sources, including by varying the operating mode of the set of sources to reduce or prevent cleaning problems that would otherwise result from weak spots if the operating mode were not so varied. Other embodiments are methods for determining positions and operating parameters (e.g., duty cycle and output acoustic wave frequency) of each source of a set of sonic sources to be used for sonically cleaning a reactor, and methods including the steps of determining a position (relative to a reactor) of each source of a set of sonic sources, positioning each said source in the determined position, and then sonically cleaning a surface of the reactor including by varying the operating mode of the set of sources to reduce or prevent cleaning problems that would otherwise result from weak spots if the operating mode were not so varied.

### CROSS-REFERENCE TO RELATED APPLICATION

The present application claims priority to Provisional U.S. Patent Application U.S. Ser. No. 60/602,936 filed Aug. 19, 2004 and is herein incorporated by reference.

### FIELD OF THE INVENTION

The invention pertains to methods for sonic cleaning of reactors (e.g., fluidized bed reactors useful for the production of polyolefins). Some embodiments of the invention pertain to operation of a set of sonic sources to clean a reactor with reduced or minimized acoustic wave cancellation, to reduce or eliminate the occurrence of weak spots (areas on the reactor surface where incident acoustic wave intensity is undesirably low).

### BACKGROUND OF THE INVENTION

The expression “weak spot” herein denotes an area on the surface of a reactor undergoing sonic cleaning, at which incident acoustic wave intensity is undesirably low as a result of acoustic wave cancellation. For example, if acoustic waves from two or more sources propagate directly to an area on a reactor wall, a weak spot can occur at the area as a result of destructive interference between the waves from different individual sources.

The expression “sonic cleaning” of a reactor herein denotes removal of undesired material from (or prevention of undesired material accumulation on) a surface of the reactor by causing acoustic radiation to be incident at the surface. A reactor can be sonically cleaned during operation of the reactor or when the reactor is not operating.

The expression “sonic source” herein denotes a source of acoustic waves suitable for use in sonic cleaning of a reactor. An example of a sonic source is a sonic cleaning device of a well-known type including a sonic tube and a sonic nozzle at the end of the tube, wherein the tube can be moved to orient the nozzle in a desired direction.

The expression herein that a sonic source operates with “fixed frequency” herein denotes that the frequency (or frequencies) of the acoustic waves emitted by the source does (or do) not change significantly over time during operation of the source.

The expressions “acoustic waves” and “sonic waves” are used interchangeably herein.

In operation, a fluidized bed reactor includes a portion having relatively low volumetric concentration of particulates (“lean phase”) and a portion having greater volumetric concentration of particulates (“dense-phase”) than the lean phase. In typical operation of a fluidized bed reactor, there is a boundary (known as a “dense-phase surface”) between lean phase and dense-phase (on top of the dense phase) in the reactor. The expression “freeboard surface” of a fluidized bed reactor herein denotes the portion of the reactor's interior surface above the dense-phase surface.

One commonly used method for producing polymers is gas phase polymerization. A conventional gas phase fluidized bed reactor used to produce polyolefins by polymerization contains a fluidized dense-phase bed including a mixture of reaction gas and polymer (resin) particles. During operation, a portion of such a reactor's interior surface is a “freeboard surface” as defined above. A “freeboard volume” within the reactor (bounded by the freeboard surface and dense-phase surface) contains mainly gas and a small amount of particles, e.g., fine particles (fines). The dense-phase bed is usually maintained in a straight (cylindrical) section of the reactor. Above the straight section, the reactor often has an “expanded” section whose diameter is larger than that of the straight section to reduce the velocity of gas flowing therethrough (to reduce the amount of fines carried out of the reactor to other downstream parts of the reaction system). The freeboard surface typically includes the interior surface of the expanded section, and (when the bed level is lower than the top of the straight section) an upper portion of the straight section's interior surface.

During operation of a fluidized bed reactor of the above-described type, fines present in the freeboard volume are either carried away by gas leaving the reactor or they fall back into the dense-phase bed. However, some fines can become attached to the interior surface of the reactor system, particularly to the freeboard surface, and can contribute to formation of layers (“sheets”) of agglomerated, melted or half-melted, resin and catalyst particles on the interior surface. Sheets can adversely affect properties of the polymer product. When sheets become heavy, they can fall off the reactor wall and plug the product discharge system or clog the distributor plate. Small pieces of sheets can be discharged together with the bulk resin particles and contribute to product quality problems by increasing the gel level of end-use products such as plastic containers and films. Sheeting and fines accumulation are sometimes collectively referred to as solid particle build-up.

Conventionally, to prevent sheeting from affecting a reactor, other parts of the reaction system, and the final product, the reactor is shut down periodically and its interior surfaces are cleaned. When a reactor is down for cleaning, large amounts of operation time are lost, and the cost of cleaning can itself be high. Thus, a method for continuously cleaning a reactor's freeboard surface and other parts of a reaction system can provide savings of time and money.

U.S. Pat. No. 5,461,123 discloses a method for sonically cleaning interior surfaces of a fluidized bed reactor (while the reactor operates to perform a polyolefin polymerization process) to protect the reactor from particle build-up. This reference teaches introducing acoustic waves into the reactor to loosen particles attached on the reactor's interior surface. The loosened particles can then be carried away from the reactor surface by gravity or drag forces.

U.S. Pat. No. 5,912,309 also discloses a method for sonically cleaning interior surfaces of a fluidized bed reactor (while the reactor operates to perform a polymerization process) to protect the reactor from particle build-up. This reference suggests that the number of sonic nozzles used to emit acoustic waves to clean a reactor's freeboard surface should depend on the reactor's freeboard volume. Specifically, the reference suggests that the number (“N”) of nozzles should satisfy the relation: V/N<5000˜7000, where “V” is the freeboard volume (in cubic feet) within the reactor (the volume bounded by the freeboard surface and dense-phase surface). Once the number of sonic nozzles has been determined, the reference teaches generally that the nozzle(s) are optimally positioned to maximize the sound pressure level over the surface to be cleaned, and that the maximization should assume a weighting function that assigns greater sound pressure level (SPL) to the incident sound pressure level at areas prone to particle build-up and lesser SPL to the incident sound pressure level at other areas.

U.S. Pat. No. 5,912,309 also teaches that after optimal sonic nozzle locations are (or an optimal nozzle is) determined, it is desirable to determine an orientation of each nozzle such that acoustic waves propagate directly (i.e., without first reflecting from one or more reactor surfaces) from the nozzle(s) to the entire surface to be cleaned. Specifically, the reference teaches that the nozzle(s) should be positioned so that each point on the surface to be cleaned is within a “cone-shaped volume” (which can have a “conical angle” smaller than about 270 degrees or smaller than about 180 degrees) defined by radiation propagating from a nozzle positioned at a “conical node,” and that “reflection acoustic waves” (that reach the surface to be cleaned after reflecting from at least one reactor surface) are less effective for surface cleaning than the direct acoustic waves.

U.S. Pat. No. 5,912,309, manifests no recognition that weak spots can occur due to destructive interference between acoustic waves emitted by sonic sources positioned in accordance with its teaching, and does not teach or suggest how to operate sonic sources to minimize or prevent the occurrence of weak spots, or how otherwise to minimize or prevent the occurrence of weak spots. Practice of the teaching of U.S. Pat. Nos. 5,461,123 and 5,912,309 will not prevent the occurrence of weak spots, and cannot ensure that weak spots will not prevent adequate cleaning of a reactor's freeboard surface or other surface.

It had not been known until the present invention how to avoid acoustic wave cancellation effects that give rise to weak spots during sonic cleaning of reactors (e.g., using acoustic waves from two or more sonic sources) or how to avoid such acoustic wave cancellation effects in an easily implemented manner. The inventors have recognized that even when sonic cleaning is performed using low-frequency acoustic (e.g., infrasonic) waves having wavelength longer than the dimension of a reactor's freeboard surface, weak spots can result when some of the acoustic waves reflect from the reactor and the reflected waves cancel other acoustic waves (e.g., reflected waves cancel each other) at various locations on the freeboard surface. The inventors have also recognized that reflected waves have a significant effect on reactor cleaning, and that the occurrence of weak spots on the freeboard surface due to reflected wave cancellation can prevent effective cleaning of the freeboard surface (e.g., polymer material that has become attached to the freeboard surface at weak spots may not be removed effectively).

### SUMMARY OF THE INVENTION

In a class of embodiments, the invention is a method for sonically cleaning a surface of a reactor (e.g., the freeboard surface of a fluidized bed reactor useful for the production of polyolefins, or a surface of a reactor of another type) using a set of sonic sources, said method including the steps of: (a) operating the set of sources in an initial operating mode to cause sonic waves incident on a surface of the reactor to produce a first set of weak spots on the surface of the reactor; and (b) after step (a), operating the set of sources in at least one other operating mode to cause sonic waves incident on the surface to produce a second set of weak spots on the surface that does not coincide with the first set of weak spots. This can reduce the time-averaged effect of weak spots at each location on the surface to prevent any location on the surface from being inadequately cleaned, and can reduce or eliminate the time-averaged effect of all or some of the weak spots in the first set. In each individual one of the operating modes, each sonic source operates with fixed frequency while active, and each sonic source in the set can operate either intermittently (e.g., can be sequentially shut off and on) or continuously (e.g., to emit sonic waves having constant or time-varying intensity) or can remain off (inactive).

The set of sonic sources typically includes more than one sonic source but in some embodiments consists of a single sonic source. The occurrence of weak spots during sonic cleaning of a reactor can be minimized or prevented in an easily implementable manner in accordance with typical embodiments of the invention. For example, in accordance with some embodiments, the operating mode of a set of sonic sources is varied over time during sonic cleaning of a reactor to reduce (e.g., minimize) acoustic wave cancellation at at least some spots on a surface of the reactor, thereby cleaning the surface more effectively than if acoustic wave cancellation were not reduced by so varying the operating mode.

The operating mode variation can be accomplished in any of many different ways, for example, by any of the following ways:

(1) sequentially shutting off different subsets of the set of sources and operating (either continuously or intermittently) each source that is not shut off;

(2) varying the intensity of acoustic waves emitted from at least one of the sources;

(3) varying the frequency of acoustic waves emitted from at least one of the sonic sources (e.g., within a small range about an optimal frequency);

(4) operating at least one of the sources (e.g., all of the sources) to emit acoustic waves having a sequence of different frequencies; and

(5) employing some sequence or combination of operations (1), (2), (3), and (4).

In typical embodiments, the inventive method achieves better cleaning performance than can be achieved by conventional sonic cleaning methods. In some preferred embodiments, operation (1), (2), (3), (4), or (5) is performed with operating parameters determined in accordance with the criterion of equation (A), set forth below. In some embodiments, a first subset of a set of sonic sources is operated to clean a reactor surface (each source in the first subset can either be operated continuously or intermittently during this step), and a second subset (different from the first subset) of the set of sonic sources is then operated to clean the reactor surface (each source in the second subset can either be operated continuously or intermittently during this step), and optionally also a third subset (different from each of the first subset and the second subset) of the set of sonic sources is then operated to clean the reactor surface (each source in the third subset can either be operated continuously or intermittently during this step).

When at least one source (of a set of sonic sources) is shut off during sonic cleaning of a reactor while the other sources are active, the incident sonic wave intensity vector at each location on the reactor wall is changed. Thus, former weak spots (at which wave cancellation took place before shut off) are no longer (after shut off) locations at which wave cancellation occurs and thus are no longer weak spots. During cleaning in accordance with the invention, it is preferred that a sufficient number of sonic sources emit acoustic waves during each time interval of the cleaning operation to prevent an intolerable decrease of overall reactor-cleaning performance. Typically, at least one sonic source emits (and preferably at least two sonic sources emit) acoustic waves during each time interval of a cleaning operation in accordance with the invention.

In a class of embodiments, adequate (e.g., complete) sonic cleaning of a reactor surface in accordance with the invention is accomplished by one or more of: preventing the occurrence of at least one weak spot on the surface, reducing or minimizing the number of weak spots (and/or the size of at least one weak spot) on the surface, changing the locations of weak spots on the surface (to reduce the time-averaged effect of weak spots at each location on the surface), and reducing the time durations during which weak spots occur at specific locations on the surface. All or some of these effects can contribute to reduction or elimination of cleaning problems that would otherwise result from weak spots, and can achieve adequate cleaning of a reactor's freeboard surface that could not be adequately cleaned by conventional sonic cleaning.

Other aspects of the invention are methods for determining positions and operating parameters (e.g., duty cycle and output acoustic wave frequency) of each source of a set of sonic sources to be used for sonically cleaning a reactor. Other aspects of the invention are methods including the steps of: (a) determining a position (relative to a reactor) of each source of a set of sonic sources; (b) positioning each said source in the position determined in step (a); and (c) after step (b), sonically cleaning a surface of the reactor including by varying the operating mode of the set of sources to reduce or prevent cleaning problems that would otherwise result from weak spots if the operating mode were not so varied.

The invention is applicable to clean many different types of reactors (e.g., fluidized bed reactors useful for the production of polyolefins, and other reactors). In various embodiments, the invention determines operating parameters for sonic cleaning of a variety of different reactors.

In a class of embodiments, operating parameters of each sonic source of a set of sonic sources are determined in accordance with the following criterion to improve reactor cleaning:

$$∯ {\sum }_{i = 1}^{N - 1} {\sum }_{j = 2}^{N} F ( {D}_{ij} ) ⅆ S = minimum , ( i \neq j ) \qquad ( A )$$

where N is the total number of sonic sources, the integration is over the surface to be sonically cleaned (e.g., the freeboard surface of a reactor) at a time when at least one (but not necessarily all) of the sources operates to emit acoustic radiation, and F(Dᵢⱼ) is defined as F(Dᵢⱼ)=1, if Dᵢⱼ=(2m+½)W, and both the ith source and the jth source are operating, and F(Dᵢⱼ)=0, if Dᵢⱼ≠(2m+½)W, or either the ith source or the jth source is shut off, where m is a non-negative integer, acoustic waves emitted by the ith source and the jth source have wavelengths in a narrow range during cleaning of the surface, W is the wavelength of at least one acoustic wave emitted by at least one of the ith source and the jth source, and Dᵢⱼ is
Dᵢⱼ=|dᵢ−dⱼ|(i≠j)
where dᵢ and dⱼ are the distances from a spot to be cleaned on the surface to the ith and jth sonic source respectively. These distances represent both the direct route and reflective routes to the spot. Typically (but not necessarily), acoustic waves emitted by the set of sonic sources have wavelengths in a narrow range (e.g., a single wavelength) at each instant during cleaning of the surface.

The criterion set forth in equation (A) can be applied at a sequence of different times, and operating parameters can be determined as a result of such multiple applications of the criterion. For example, each performance of the minimization can assume a different value of the wavelength W, or can assume that a different subset of a full set of sonic sources operates (e.g., where a sequence of different subsets of the full set are shut off while the other sources operate continuously or intermittently). The minimization can be performed multiple times to determine a sequence of operating parameter sets (e.g., a sequence that minimizes in some sense the summed or otherwise combined results of all such minimizations). Operation of sonic sources whose operating parameters have been determined in accordance with the criterion of equation (A), e.g., by operating the sources in a sequence of different operating modes, can improve reactor cleaning in any of several different ways, including in one or more of the following ways: by eliminating or minimizing weak spots, by varying the locations of weak spots, and by reducing the time intervals during which weak spots occur at specific locations of the surface to be cleaned.

### DESCRIPTION OF THE DRAWINGS

FIG. 1 is a simplified cross-sectional view of a fluidized bed reactor (10) with four sonic sources mounted in positions for cleaning the reactor's freeboard surface (20), and a control unit (60) for controlling operation of the sonic sources.

FIG. 2 is a simplified cross-sectional view of another fluidized bed reactor that can be cleaned in accordance with the invention.

FIG. 3 is a simplified cross-sectional view of another fluidized bed reactor that can be cleaned in accordance with the invention.

### DETAILED DESCRIPTION OF PREFERRED EMBODIMENTS

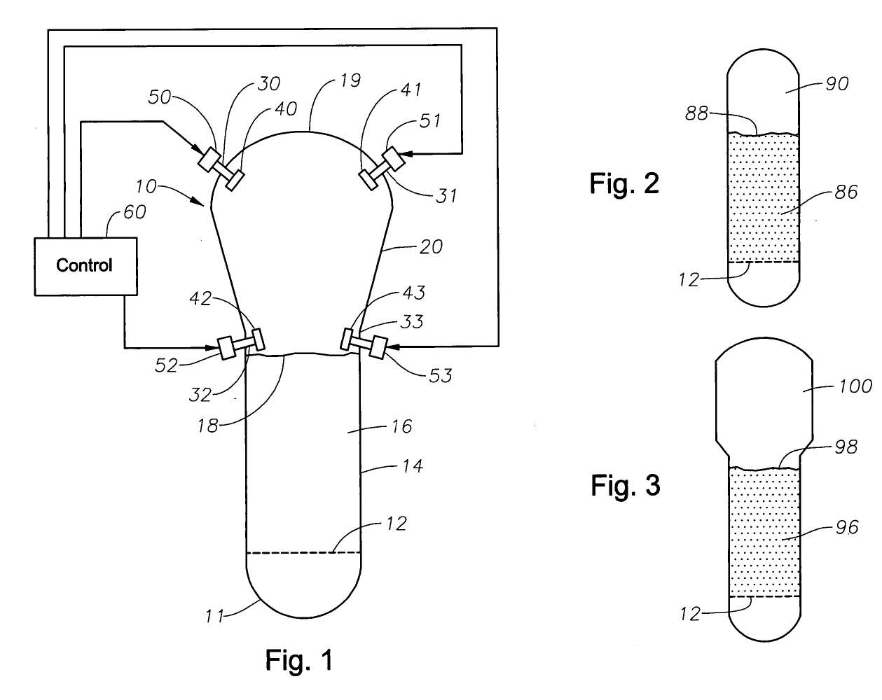

An embodiment of the inventive reactor system will be described with reference to FIG. 1. The FIG. 1 system includes fluidized bed reactor 10. Reactor 10 has a bottom end 11, a top section 19, a cylindrical (straight) section 14 between bottom end 11 and top section 19, and a distributor plate 12 within section 14. The diameter of each horizontal cross-section of section 19 is greater than the diameter of straight section 14. In operation, dense-phase surface 18 is the boundary between lean phase portion present within reactor 10 (above dense-phase surface 18) and dense-phase portion 16 within reactor 10 (in the volume bounded by section 14, plate 12, and surface 18). In operation, freeboard surface 20 of reactor 10 includes the inner surface of top section 19 and the portion of the inner surface of section 14 above surface 18.

The FIG. 1 system also includes four sonic sources mounted in positions for cleaning reactor 10's freeboard surface 20. One sonic source includes wave generation unit 50, nozzle 40, and sonic tube 30 between unit 50 and nozzle 40. A second sonic source includes wave generation unit 51, nozzle 41, and sonic tube 31 between unit 51 and nozzle 41. A third sonic source includes wave generation unit 52, nozzle 42, and sonic tube 32 between unit 52 and nozzle 42. A fourth sonic source includes wave generation unit 53, nozzle 43, and sonic tube 33 between unit 53 and nozzle 43. During sonic cleaning of reactor 10, each sonic source is controlled by control unit 60. Preferably, unit 60 is configured (e.g., programmed) in accordance with the invention to operate (during sonic cleaning) to cause at least one of the sonic sources to emit acoustic waves intermittently (or to vary the intensity of acoustic waves emitted by at least one of the sonic sources); and/or to vary the frequency of acoustic waves emitted from at least one of the sonic sources (preferably within a small range about an optimal frequency).

Each of tubes 30, 31, 32, and 33 is fixed or moveable, preferably fixed, to orient the nozzle coupled thereto (one of nozzles 40, 41, 42, and 43) as desired relative to surface 20. The positions of the four sonic sources and the orientation of each of nozzles 40, 41, 42, and 43 (relative to freeboard surface 20) are determined in accordance with the invention.

For example, in one embodiment, nozzles 42 and 43 are oriented horizontally and positioned in a first horizontal plane at azimuthal positions of 0 and 180 degrees, respectively (about the central longitudinal axis of the reactor), nozzle 40 is oriented at an angle of 20 degrees above horizontal and positioned in a second horizontal plane (above the first horizontal plane) at an azimuthal position of 90 degrees, and nozzle 42 is oriented at an angle of 20 degrees above horizontal in the second horizontal plane at an azimuthal position of 270 degrees. These nozzles (or other sets of nozzles) can have any of many other positions and orientations in other embodiments.

If control unit 60 shuts off one or more of the sonic sources (or causes at least one of the sources to emit acoustic waves with reduced intensity) to eliminate one or more weak spots on surface 20, the change in state of the system can cause at least one other location on surface 20 (that was formerly not a weak spot) to become a new weak spot. Thus, it desirable in typical embodiments of the invention for control unit 60 to shut off (or operate with reduced intensity) a sequence of the sonic sources so as to minimize the overall effect of weak spots on sonic cleaning of surface 20 (e.g., by minimizing time-averaged occurrence of weak spots at all locations on surface 20). Preferably, the duration of any weak spot that occurs on surface 20 is limited, so that a weak spot occurs at any location on surface 20 only intermittently and temporarily if at all. By avoiding the occurrence of fixed weak spots on freeboard surface 20 for undesirably long time intervals, the entire freeboard surface 20 can be cleaned adequately by sonic waves. Similarly, by avoiding the occurrence of fixed weak spots anywhere on the interior wall of reactor 10 for undesirably long time intervals, the entire interior wall of reactor 10 can be cleaned adequately by sonic waves.

In preferred embodiments of the invention, at all times during sonic cleaning, a sufficient number of sonic sources emit acoustic waves to prevent an intolerable decrease of overall reactor-cleaning performance. Typically, at least one sonic source, and preferably at least two sonic sources are emitting acoustic waves at any time during sonic cleaning.

When control unit 60 changes the frequency of the acoustic waves emitted by any of the sonic sources (or the frequency of each of two or more frequency components of the output of such a source), the wavelength(s) of the emitted radiation change so as to change the locations on the interior wall of reactor 10 at which acoustic wave cancellation occurs. By appropriately varying the frequency (or frequencies) of the acoustic radiation output of some or all of the sonic sources, the number of weak spots that occur on surface 20 can be reduced and/or the locations of the weak spots that do occur can be varied to reduce or minimize the overall effect of weak spots on sonic cleaning of surface 20 (e.g., by minimizing time-averaged occurrence of weak spots at all locations on surface 20).

In a class of preferred embodiments of the inventive sonic cleaning method, each sonic source (of a set of sonic sources) emits acoustic radiation having a narrow range of frequencies about a center frequency. For example, in some cases in which each source includes a sonic nozzle at the end of a sonic tube, the center frequency corresponds to a wavelength equal to 4L (where L is the length of the sonic tube). The frequency of the radiation emitted from the source is varied within a small range to reduce or minimize the overall effect of weak spots on sonic cleaning of the reactor surface to be cleaned. For example, the time-varying frequency, f(t), of each frequency component of the emitted radiation is varied within the range f0−Δf≦f(t)≦f0+Δf, (where f0 is the time average of f(t), and Δf is much smaller than the center frequency). The frequency variation can be accomplished either continuously or in step changes within the frequency range. In some embodiments, the ratio Δf/f0 is at least substantially equal to 3% or 4% or 5% or 6%.

The timing with which sonic frequency is varied in accordance with the invention is determined by operational need. In some embodiments, sonic frequency is varied during at least one step of an operating cycle, and each such step has a duration of less than one day (e.g., each step can have duration in the range from five minutes to one hour). The total period in which frequency variation occurs is typically 10% to 90% (e.g., 20% to 70%) of the overall duration of the cleaning operation. To implement frequency variation, any pattern of frequency adjustment (e.g., several step changes with different duration for each step, linear continuous change, swing change, and so on) can be employed.

For convenience, the sonic sources of FIG. 1 will sometimes be referred to as follows: the source including nozzle 40 is source #1, the source including nozzle 41 is source #2, the source including nozzle 42 is source #3, and the source including nozzle 43 is source #4.

In one exemplary embodiment of the invention, control unit 60 causes each of the four sonic nozzles of FIG. 1 to operate intermittently as follows:

(1) during a first step of duration T, all four of sources #1, #2, #3, and #4 are operated;

(2) then (during a next step of duration T), only sources #1, #2, and #3 are operated (#4 is shut off);

(3) then (during a next step of duration T), only sources #1, #2, and #4 are operated (#3 is shut off);

(4) then (during a next step of duration T), only sources #1, #3, and #4 are operated (#2 is shut off); and

(5) then (during a next step of duration T), only sources #2, #3, and #4 are operated (#1 is shut off). This five-step sequence is repeated during each cleaning session.

In another exemplary embodiment of the invention, control unit 60 causes each of the four sonic nozzles of FIG. 1 to operate intermittently as follows:

(1) during a first step of duration T, all four of sources #1, #2, #3, and #4 are operated;

(2) then (during a next step of duration T), only sources #1, #2, and #3 are operated (#4 is shut off);

(3) then (during a next step of duration T), all four of sources #1, #2, #3, and #4 are operated;

(4) then (during a next step of duration T), only sources #1, #2, and #4 are operated (#3 is shut off);

(5) then (during a next step of duration T), all four of sources #1, #2, #3, and #4 are operated;

(6) then (during a next step of duration T), only sources #1, #3, and #4 are operated (#2 is shut off);

(7) then (during a next step of duration T), all four of sources #1, #2, #3, and #4 are operated; and

(8) then (during a next step of duration T), only sources #2, #3, and #4 are operated (#1 is shut off). This eight-step sequence is repeated during each cleaning session.

In other embodiments (including variations on the two described examples), other sequences of subsets of the sources are operated. For, example, sequences of two-source subsets of the four sonic sources can be operated (e.g., sources #1 and #2, then sources #3 and #4, then sources #1 and #3, then sources #2 and #4, then sources #1 and #4 some embodiments, the frequency of the acoustic output of each source is fixed (e.g., at an optimized design frequency). In other embodiments, the frequency of the acoustic output of all or some of the sources is varied.

In a class of embodiments of the invention, sonic sources are operated to clean a polished reactor surface (e.g., to achieve improved anti-fouling performance). Commonly, all or part of the freeboard surface of a fluidized bed reactor is a polished surface. Unless adequately cleaned, polished surfaces of fluidized bed reactors typically have fouling rates similar to those of surfaces (in reactors of the same or similar type) having standard, non-polished wall finishes. Since a polished surface has fewer fouling-prone sites in which particles can lodge, a polished surface can typically be sonically cleaned with higher efficiency (in loosening and breaking attachment between particles and the surface) than can a surface having a non-polished finish.

FIG. 2 is a simplified cross-sectional view of another fluidized bed reactor that can be cleaned in accordance with the invention. The FIG. 2 reactor has a cylindrical (straight) section between its bottom end and its top section, and a distributor plate 12 within the straight section. In operation, dense-phase surface 88 is the boundary between lean phase portion within the reactor (above dense-phase surface 88) and dense-phase portion 86 within the reactor (in the volume bounded by the straight section, plate 12, and surface 88). In operation, freeboard surface 90 of the reactor is exposed to the lean phase material above surface 88. Sonic sources can be positioned in accordance with the invention to clean freeboard surface 90.

FIG. 3 is a simplified cross-sectional view of another fluidized bed reactor that can be cleaned in accordance with the invention. The FIG. 3 reactor has a cylindrical (straight) section between its bottom end and its top section, and a distributor plate 12 within the straight section. The diameter of each horizontal cross-section of the top section is greater than the diameter of the straight section, but the top section of the FIG. 3 reactor is shaped differently than the top section of reactor 10 of FIG. 1. In operation of the FIG. 3 reactor, dense-phase surface 98 is the boundary between lean phase portion within the reactor (above dense-phase surface 98) and dense-phase portion 96 within the reactor (in the volume bounded by the straight section, plate 12, and surface 98). In operation, freeboard surface 100 of the FIG. 3 reactor is exposed to the lean phase material above surface 98. Sonic sources can be positioned in accordance with the invention to clean freeboard surface 100.

We next describe examples of commercial-scale, sonic cleaning operations conducted in accordance with the invention in a gas-phase fluidized-bed polymerization reactor having the geometry of reactor 10 of FIG. 1. Detailed operating conditions and cleaning results for the examples are listed in Tables 1 and 2. The examples assume that the diameter of the reactor's straight section (section 14) is 4.42 m, the height of straight section 14 (above distributor plate 12) is 15.24 m, the height of conical (lower) portion of top section 19 is 6.22 m, and the diameter of the hemispherical (upper) portion of top section 19 is 7.01 m.

TABLE 1

| | Example | | | |
|---|---|---|---|---|
| | 1A | 1 | 2A | 2 |
| Product | PE | PE | EPDM | EPDM |
| Bed-level (m) | 14.48 | 14.48 | 14.48 | 14.48 |
| Number of sonic nozzles | 4 | 4 | 4 | 4 |
| Volume-to-nozzle ratio | 66 | 66 | 66 | 66 |
| (m³/nozzle) | | | | |
| Sonic pipe length (in units of | ¼ | ¼ | ¼ | ¼ |
| one wavelength of acoustic | | | | |
| radiation having the optimal | | | | |
| sonic frequency) | | | | |
| Sonic pipe inner diameter (m.) | 0.1 | 0.1 | 0.1 | 0.1 |
| Standard SPL (dB)^{a} | 150 | 150 | 148 | 148 |
| Optimal sonic frequency (Hz) | 16.5 | 16.5 | 17 | 17 |
| Sound wave duration (sec) | 30 | 30 | 30 | 30 |
| Sound wave interval (sec) | 240 | 240 | 240 | 240 |
| Sonic pipe insertion length | 0 | 0 | 0 | 0 |
| Product gel ranking^{b} | 2 | 1 | N/A | N/A |
| Change of Sonic Frequency? | No | No | No | Yes |
| Shut off of different subsets of | No | Yes | No | No |
| the sonic sources? | | | | |
| Particle build-up (1-3 month | Some spots | No | Some | No |
| operation) | in the | | spots | |
| | reactor | | in the | |
| | dome | | reactor | |
| | | | dome | |

^{a}measured at 1 meter from the sonic nozzle, when only one sonic nozzle is working.
^{b}1: best (no gel), 2: second best, 5: worst.

TABLE 2

| | Example | | | |
|---|---|---|---|---|
| | 1A | 1 | 2A | 2 |
| Reactor temperature | 107 | 107 | 45 | 45 |
| (° C.) | | | | |
| Reactor pressure (psig) | 300 | 300 | 400 | 400 |
| Catalyst type | chromium | chromium | vanadium | vanadium |
| Superficial gas velocity | 2.6 | 2.6 | 1.6 | 1.6 |
| (ft/sec) | | | | |
| Ethylene partial pressure | 200 | 200 | 80 | 80 |
| (psi) | | | | |
| Hydrogen to ethylene | 0.045 | 0.045 | 0.01 | 0.01 |
| molar ratio | | | | |
| 1-hexene to ethylene | 0.0018 | 0.0018 | N/A | N/A |
| molar ratio | | | | |
| Propylene partial | N/A | N/A | 184 | 184 |
| pressure | | | | |
| Ethylidene-norbornene | N/A | N/A | 20-40 | 20-40 |
| concentration (ppm) | | | | |
| Product density (g/cm³) | about | about | N/A | N/A |
| | 0.953 | 0.953 | | |
| Product flow index | about 40 | about 40 | N/A | N/A |
| (g/10 min.) | | | | |

In Example 1, the freeboard source of a gas-phase fluidized-bed reactor operating to manufacture polyethylene was sonically cleaned in accordance with an embodiment of the inventive method. Parameters and cleaning results for Example 1 are set forth in the second column from the left of each of Tables 1 and 2. Example 1 was effective to remove solid particle build-up from the freeboard surface of the reactor after test periods having duration in the range from 1 month to 3 months. In Example 1, different subsets individual sources of a set of four sonic sources were sequentially operated during the test period (in a sequence to be described below) to accomplish sonic cleaning of the freeboard surface in accordance with the invention. Conventional cleaning of same reactor, with all sources in the same set of sonic sources controlled in a conventional manner to operate simultaneously (i.e., all four sources off at the same time, and all four sources on at the same time), but with all other reaction and cleaning parameters as in Example 1, is referred to as Example “1A.” Parameters and cleaning results of Example 1A are set forth in the left column of each of Tables 1 and 2.

In Example 2, the freeboard source of a gas-phase fluidized-bed reactor operating to manufacture ethylene/propylene/diene rubber was sonically cleaned in accordance with an embodiment of the inventive method. Parameters and cleaning results for Example 2 are set forth in the right column in each of Tables 1 and 2. Example 2 was effective to remove solid particle build-up from the freeboard surface of the reactor after test periods having duration in the range from 1 month to 3 months. In Example 2, all sources in a set of four sonic sources were controlled to operate simultaneously (i.e., all four sources off at the same time, and all four sources on at the same time), but with time varying output frequency (in a manner to be described below) to accomplish sonic cleaning of the freeboard surface in accordance with the invention. Conventional cleaning of same reactor, with all sources in the same set of sources controlled in a conventional manner to operate simultaneously and with fixed output frequency, but with all other reaction and cleaning parameters as in Example 2, is referred to as Example “2A.” Parameters and cleaning results of Example 2A are set forth in the second column from the right in each of Tables 1 and 2.

The same four sonic sources were used in each of Examples 1, 1A, 2, and 2A. Each source had a sonic nozzle whose distal end was positioned flush with the interior surface of the reactor. The sonic nozzles of the four sources (referred to as nozzles #1, #2, #3, and #4) were positioned and oriented as follows: nozzle #1 was positioned 20.08 meters above distributor plate 12 with horizontal orientation and in an azimuthal position of 0 degrees (about the central longitudinal axis of the reactor), nozzle #2 was positioned 23.01 meters above distributor plate 12 in an orientation of 20 degrees above horizontal and in an azimuthal position of 90 degrees, nozzle #3 was positioned 20.08 meters above distributor plate 12 with horizontal orientation and in an azimuthal position of 180 degrees, and nozzle #4 was positioned 23.01 meters above distributor plate 12 in an orientation of 20 degrees above horizontal and in an azimuthal position of 270 degrees.

In Example 1A, the reactor was operated to perform polymerization during test periods having duration in the range from 1 month to 3 months, while the sonic sources continuously cycled through a duty cycle (of duration 270 seconds) in which all four sources were operated for 30 seconds (to emit acoustic waves having the indicated “optimal” frequency of 16.5 Hz) and then all four sources were shut off for the next 240 seconds. At the end of each test period, a resin was determined to have built-up with thickness in the range from about 0.005 m to 0.025 m at some spots on the freeboard surface. During the test periods, the product gel level was measured every 4 to 6 hours and product gel level was determined to be generally good, but less than perfect.

In Example 1, the reactor was also operated to perform polymerization during test periods having duration in the range from 1 month to 3 months, while the sonic sources were continuously cycled through a five step operation (of duration 7*270=1890 seconds) including the following sequence of steps: first, all sources operated for three cycles (each of duration 270 seconds), wherein during each cycle all four sources operated for the first 30 seconds (to emit acoustic waves having the indicated “optimal” frequency of 16.5 Hz) and none of the sources operated for the next 240 seconds; then, only the first, second, and third sources operated during a second step in which nozzles #1, #2, and #3 emitted acoustic waves having the optimal frequency for first 30 seconds and none of the sources operated for the next 240 seconds; then, only the first, second, and fourth sources operated during a third step in which nozzles #1, #2, and #4 emitted acoustic waves having the optimal frequency for first 30 seconds and none of the sources operated for the next 240 seconds; then, only the first, third, and fourth sources operated during a fourth step in which nozzles #1, #3, and #4 emitted acoustic waves having the optimal frequency for first 30 seconds and none of the sources operated for the next 240 seconds; and then, only the second, third, and fourth sources operated during a fifth step in which nozzles #2, #3, and #4 emitted acoustic waves having the optimal frequency for first 30 seconds and none of the sources operated for the next 240 seconds. At the end of each test period, no resin was determined to have built-up on the freeboard surface. During the test periods, the product gel level was measured every 4 to 6 hours and product quality was determined to be excellent (no gels were observed).

In Example 2A, the reactor was operated to manufacture ethylene/propylene/diene rubber (EPDM polymerization was performed) during test periods having duration in the range from 1 month to 3 months, while the sonic sources continuously cycled through a duty cycle (of duration 270 seconds) in which all four sources were operated for 30 seconds (to emit acoustic waves having the indicated “optimal” frequency of 17 Hz) and then all four sources were shut off for the next 240 seconds. Carbon black particles are added intermittently to the reactor to keep the electrostatic activity level under control and to prevent the sticky polymer from agglomerating. At the end of each test period, resin was determined to have built-up with thickness in the range from about 0.005 m to 0.025 m at some spots on the freeboard surface. Although the reactor operation was not severely upset (i.e., there was no reactor shutdown), rubbles were found in the discharged product.

In Example 2, the reactor was operated to manufacture ethylene/propylene/diene rubber (EPDM polymerization was performed) during test periods having duration in the range from I month to 3 months, while the sonic sources were continuously cycled through a three step operation (of duration 14*270=3780 seconds) including the followings steps: first, all sources operated for ten cycles (each of duration 270 seconds), wherein during each cycle all four sources operated for the first 30 seconds (to emit acoustic waves having the indicated “optimal” frequency of 17 Hz) and none of the sources operated for the next 240 seconds; then all sources operated for two cycles (each of duration 270 seconds), wherein during each of these cycles all four sources operated for the first 30 seconds to emit acoustic waves having frequency 90%*(17 Hz) =15.3 Hz and none of the sources operated for the next 240 seconds; and then all sources operated for two cycles (each of duration 270 seconds), wherein during each of these cycles all four sources operated for the first 30 seconds to emit acoustic waves having frequency 110%*(17 Hz)=18.7 Hz and none of the sources operated for the next 240 seconds. Carbon black particles are added intermittently to the reactor to keep the electrostatic activity level under control and to prevent the sticky polymer from agglomerating. At the end of each test period, no resin was determined to have built-up on the freeboard surface.

In different embodiments, the invention determines operating parameters for sonic cleaning of a variety of different reactors. In different embodiments, any of a variety of different reactors is sonically cleaned in accordance with the invention. For example the invention can be implemented to clean a surface (e.g., a freeboard surface of a continuous gas phase fluidized bed reactor).

In some embodiments, continuous gas phase fluidized bed reactor is cleaned in accordance with the invention while it operates to perform polymerization as follows. The fluidized bed is made up of polymer granules. Gaseous feed streams of ethylene and hydrogen together with liquid comonomer are mixed together in a mixing tee arrangement and introduced below the reactor bed into the recycle gas line. Optionally, the comonomer is hexene. The individual flow rates of ethylene, hydrogen and comonomer are controlled to maintain fixed composition targets. The ethylene concentration is controlled to maintain a constant ethylene partial pressure. The hydrogen is controlled to maintain a constant hydrogen to ethylene mole ratio. The concentration of all gases is measured by an on-line gas chromatograph to ensure relatively constant composition in the recycle gas stream. A solid catalyst is injected directly into the fluidized bed using purified nitrogen as a carrier. Its rate is adjusted to maintain a constant production rate. The reacting bed of growing polymer particles is maintained in a fluidized state by the continuous flow of the make up feed and recycle gas through the reaction zone. In some implementations, a superficial gas velocity of

1 -3 ft/sec is used to achieve this, and the reactor is operated at a total pressure of 300 psig. To maintain a constant reactor temperature, the temperature of the recycle gas is continuously adjusted up or down to accommodate any changes in the rate of heat generation due to the polymerization. The fluidized bed is maintained at a constant height by withdrawing a portion of the bed at a rate equal to the rate of formation of particulate product. The product is removed semi-continuously via a series of valves into a fixed volume chamber, which is simultaneously vented back to the reactor. This allows for highly efficient removal of the product, while at the same time recycling a large portion of the unreacted gases back to the reactor. This product is purged to remove entrained hydrocarbons and treated with a small steam of humidified nitrogen to deactivate any trace quantities of residual catalyst.

In other embodiments, a reactor is cleaned in accordance with the invention while it operates to perform polymerization using any of a variety of different processes (e.g., solution, slurry, or gas phase processes). For example, the reactor can be a fluidized bed reactor operating to produce polyolefin polymers by a gas phase polymerization process. This type of reactor and means for operating such a reactor are well known. In operation of such reactors to perform gas phase polymerization processes, the polymerization medium can be mechanically agitated or fluidized by the continuous flow of the gaseous monomer and diluent.

The reactor temperature of the fluidized bed process can range from 30° C. or 40° C. or 50° C. to 90° C. or 100IC or 1 10C or 120° C. or 150° C. In general, the reactor temp operated at the highest temperature that is feasible taking into account the sintering temperature of the polymer product within the reactor. Regardless of the process used to make polyolefins during sonic cleaning in accordance with the invention, the polymerization temperature, or reaction temperature should be below the melting or “sintering” temperature of the polymer to be formed. Thus, the upper temperature limit in one embodiment is the melting temperature of the polyolefin produced in the reactor.

In other embodiments of the invention, polymerization is effected by a slurry polymerization process. A slurry polymerization process generally uses pressures in the range of from 1 to 50 atmospheres and even greater and temperatures in the range of 0° C. to 120° C., and more particularly from 30° C. to 100° C. In a slurry polymerization, a suspension of solid, particulate polymer is formed in a liquid polymerization diluent medium to which ethylene and comonomers and often hydrogen along with catalyst are added. The suspension including diluent is intermittently or continuously removed from the reactor where the volatile components are separated from the polymer and recycled, optionally after a distillation, to the reactor. The liquid diluent employed in the polymerization medium is typically an alkane having from 3 to 7 carbon atoms, a branched alkane in one embodiment. The medium employed should be liquid under the conditions of polymerization and relatively inert. When a propane medium is used the process must be operated above the reaction diluent critical temperature and pressure. In one embodiment, a hexane, isopentane or isobutane medium is employed.

In other embodiments, a reactor undergoing sonic cleaning in accordance with the invention performs particle form polymerization, or a slurry process in which the temperature is kept below the temperature at which the polymer goes into solution. In other embodiments, a reactor undergoing sonic cleaning in accordance with the invention is a loop reactor or one of a plurality of stirred reactors in series, parallel, or combinations thereof. Non-limiting examples of slurry processes include continuous loop or stirred tank processes.

A reactor undergoing sonic cleaning in accordance with the invention can operate to produce homopolymers of olefins, e.g., ethylene, and/or copolymers, terpolymers, and the like, of olefins, particularly ethylene, and at least one other olefin. The olefins, for example, may contain from 2 to 16 carbon atoms in one embodiment; and in another embodiment, ethylene and a comonomer comprising from 3 to 12 carbon atoms in another embodiment; and ethylene and a comonomer comprising from 4 to 10 carbon atoms in yet another embodiment; and ethylene and a comonomer comprising from 4 to 8 carbon atoms in yet another embodiment. A reactor undergoing sonic cleaning in accordance with the invention can operate to produce polyethylenes. Such polyethylenes can be homopolymers of ethylene and interpolymers of ethylene and at least one a-olefin wherein the ethylene content is at least about 50% by weight of the total monomers involved. Exemplary olefins that may be utilized in embodiments of the invention are ethylene, propylene, 1-butene, 1-pentene, 1-hexene, 1-heptene, 1-octene, 4-methylpent-1-ene, 1-decene, 1-dodecene, 1-hexadecene and the like. Also utilizable herein are polyenes such as 1,3-hexadiene, 1,4-hexadiene, cyclopentadiene, dicyclopentadiene, 4-vinylcyclohex-1-ene, 1,5-cyclooctadiene, 5-vinylidene-2-norbornene and 5-vinyl-2-norbornene, and olefins formed in situ in the polymerization medium. When olefins are formed in situ in the polymerization medium, the formation of polyolefins containing long chain branching may occur.

In the production of polyethylene or polypropylene, comonomers may be present in the polymerization reactor. When present, the comonomer may be present at any level with the ethylene or propylene monomer that will achieve the desired weight percent incorporation of the comonomer into the finished resin. In one embodiment of polyethylene production, the comonomer is present with ethylene in a mole ratio range of from 0.0001 (comonomer:ethylene) to 50, and from 0.0001 to 5 in another embodiment, and from 0.0005 to 1.0 in yet another embodiment, and from 0.001 to 0.5 in yet another embodiment. Expressed in absolute terms, in making polyethylene, the amount of ethylene present in the polymerization reactor may range to up to 1000 atmospheres pressure in one embodiment, and up to 500 atmospheres pressure in another embodiment, and up to 200 atmospheres pressure in yet another embodiment, and up to 100 atmospheres in yet another embodiment, and up to 50 atmospheres in yet another embodiment.

Hydrogen gas is often used in olefin polymerization to control the final properties of the polyolefin. For some types of catalyst systems, it is known that increasing concentrations (partial pressures) of hydrogen increase the melt flow ratio (MFR, or I₂₁/I₂) and/or melt index (MI, or I₂) of the polyolefin generated. The MFR or MI can thus be influenced by the hydrogen concentration. The amount of hydrogen in the polymerization can be expressed as a mole ratio relative to the total polymerizable monomer, for example, ethylene, or a blend of ethylene and hexane or propene. The amount of hydrogen used in some polymerization processes is an amount necessary to achieve the desired MFR or MI of the final polyolefin resin. In one embodiment, the mole ratio of hydrogen to total monomer (H₂:monomer) is in a range of from greater than 0.0001 in one embodiment, and from greater than 0.0005 in another embodiment, and from greater than 0.001 in yet another embodiment, and less than 10 in yet another embodiment, and less than 5 in yet another embodiment, and less than 3 in yet another embodiment, and less than 0.10 in yet another embodiment, wherein a desirable range may comprise any combination of any upper mole ratio limit with any lower mole ratio limit described herein. Expressed another way, the amount of hydrogen in the reactor at any time may range to up to 5000 ppm, and up to 4000 ppm in another embodiment, and up to 3000 ppm in yet another embodiment, and between 50 ppm and 5000 ppm in yet another embodiment, and between 500 ppm and 2000 ppm in another embodiment.

A reactor undergoing sonic cleaning in accordance with the invention can be an element of a staged reactor employing two or more reactors in series, wherein one reactor may produce, for example, a high molecular weight component and another reactor may produce a low molecular weight component.

A reactor undergoing sonic cleaning in accordance with the invention can be implement a slurry or gas phase process in the presence of a bulky ligand metallocene-type catalyst system and in the absence of, or essentially free of, any scavengers, such as triethylaluminum, trimethylaluminum, tri-isobutylaluminum and tri-n-hexylaluminum and diethyl aluminum chloride, dibutyl zinc and the like. By “essentially free”, it is meant that these compounds are not deliberately added to the reactor or any reactor components, and if present, are present to less than 1 ppm in the reactor.

A reactor undergoing sonic cleaning in accordance with the invention can employ one or more catalysts combined with up to 10 wt % of a metal-fatty acid compound, such as, for example, an aluminum stearate, based upon the weight of the catalyst system (or its components). Other metals that may be suitable include other Group 2 and Group 5-13 metals. In other embodiments, a solution of the metal-fatty acid compound is fed into the reactor. In other embodiments, the metal-fatty acid compound is mixed with the catalyst and fed into the reactor separately. These agents may be mixed with the catalyst or may be fed into the reactor in a solution or a slurry with or without the catalyst system or its components.

In a reactor undergoing sonic cleaning in accordance with the invention, supported catalyst(s) can be combined with activators and can be combined by tumbling and/or other suitable means, with up to 2.5 wt % (by weight of the catalyst composition) of an antistatic agent, such as an ethoxylated or methoxylated amine, an example of which is Kemamine AS-990 (ICI Specialties, Bloomington Del.).

Examples of polymers that can be produced by a reactor undergoing sonic cleaning in accordance with the invention include the following: homopolymers and copolymers of C2-C18 alpha olefins; polyvinyl chlorides, ethylene propylene rubbers (EPRs); ethylene-propylene diene rubbers (EPDMs); polyisoprene; polystyrene; polybutadiene; polymers of butadiene copolymerized with styrene; polymers of butadiene copolymerized with isoprene; polymers of butadiene with acrylonitrile; polymers of isobutylene copolymerized with isoprene; ethylene butene rubbers and ethylene butene diene rubbers; and polychloroprene; norbornene homopolymers and copolymers with one or more C2-C18 alpha olefin; terpolymers of one or more C2 -C18 alpha olefins with a diene.

Monomers that can be present in a reactor undergoing sonic cleaning in accordance with the invention include one or more of: C2 -C18 alpha olefins such as ethylene, propylene, and optionally at least one diene, for example, hexadiene, dicyclopentadiene, octadiene including methyloctadiene (e.g., 1-methyl-1,6-octadiene and 7-methyl-1,6-octadiene), norbornadiene, and ethylidene norbornene; and readily condensable monomers, for example, isoprene, styrene, butadiene, isobutylene, chloroprene, acrylonitrile, cyclic olefins such as norbornenes.

A reactor undergoing sonic cleaning in accordance with some embodiments of the invention can be used in conjunction with slurry, solution, bulk, stirred bed and fluidized bed polymerizations. An interior surface above the dense-phase (including gas-solid dense phase, slurry phase, or solution phase) surface in any such reactor can be sonically cleaned and/or protected against particle accumulation using sonic sources that are operated in accordance with this invention. Also, surfaces below the dense-phase surface can be partially or completely protected, especially when liquid exists in the dense phase.

A reactor undergoing sonic cleaning in accordance with some embodiments of the invention can perform fluidized bed polymerizations (e.g., mechanically stirred and/or gas fluidized). The reactor can be used to perform any type of fluidized or gas phase polymerization reaction and the reaction can be carried out in a single reactor or multiple reactors such as two or more reactors in series. Conventional gas phase polymerization, “condensing mode” (including induced condensing mode) polymerization, or “liquid monomer” polymerization can be performed by the reactor.

In various embodiments, any of many different types of polymerization catalysts can be used in a polymerization process performed by a reactor undergoing sonic cleaning in accordance with the present invention. A single catalyst may be used, or a mixture of catalysts may be employed, if desired. The catalyst can be soluble or insoluble, supported or unsupported. It may be a prepolymer, spray dried with or without a filler, a liquid, or a solution, slurry/suspension or dispersion. These catalysts are used with cocatalysts and promoters well known in the art. Typically these are alkylaluminums, alkylaluminum halides, alkylaluminum hydrides, as well as aluminoxanes. For illustrative purposes only, examples of suitable catalysts include Ziegler-Natta catalysts, Chromium based catalysts, Vanadium based catalysts (e.g., vanadium oxychloride and vanadium acetylacetonate), Metallocene catalysts and other single-site or single-site-like catalysts, Cationic forms of metal halides (e.g., aluminum trihalides), anionic initiators (e.g., butyl lithiums), Cobalt catalysts and mixtures thereof, Nickel catalysts and mixtures thereof, Iron catalysts and mixtures thereof, rare earth metal catalysts (i.e., those containing a metal having an atomic number in the Periodic Table of 57 to 103), such as compounds of cerium, lanthanum, praseodymium, gadolinium and neodymium.

In various embodiments, the polymerization process performed by a reactor undergoing sonic cleaning in accordance with the present invention can employ other additives, such as (for example) inert particulate particles.

In order to achieve desired performance of sonic sources, it is necessary to select many design and operating parameters and determine their optimum ranges. Those parameters include standard sound pressure level of a sonic source, minimum sound pressure level on the entire surface to be cleaned, sound wave frequency, sonic tube lengths, sound wave duration and interval, number of sonic sources, locations and orientations of sonic sources (e.g., orientations of sonic nozzles), insertion lengths and diameters of sonic tubes, and sonic tube configurations. The frequency or frequencies of acoustic waves used in accordance with the invention can be within one or both of the audible and non-audible ranges.

The sound energy introduced by a sonic source employed in accordance with the invention typically must be able to dislodge polymer particles, fines, sheets or other particles from the reactor surface to be cleaned. A parameter called Standard Sound Pressure Level (SSPL) can be used to measure the energy level of a sound wave producing device. SSPL is defined as the Sound Pressure Level (SPL) measured at 1 meter away from a sonic source (e.g., the sonic nozzle) in the absence of obvious interference contributed by the reflected sound waves. The SSPL of each sonic source employed in typical embodiments of the invention is typically from about 100 to 200 decibels (dB).

The reactor surface to be cleaned and/or protected (e.g., the freeboard surface) should be cleaned and/or protected by sound waves with sufficient energy to prevent particle accumulation. The SPLs at different locations of the surface to be cleaned are usually different due to different distances from the sonic nozzle(s), etc. The minimum Sound Pressure Level (mSPL) on the entire surface to be cleaned is an index to measure the effectiveness of sound waves in preventing solid particle build-up. In practicing the present invention, the minimum SPL on the entire surface to be cleaned in the reactor system is typically from about 100 dB to 200 dB.

Sound waves employed in the present invention are typically of a frequency suitable to dislodge polymer particles, fines, sheets or other particles from the interior surfaces of the reactor system. When the frequency is too high, the particles attached on the reactor wall cannot effectively be loosened. When, the frequency is too low, the sonic tube used to generate the sound wave must be so long as to cause undesirable sound energy loss. The sound wave frequency employed in the present invention can be in the non-audible infrasonic wave range (e.g., less than 20 Hz) or the audible sonic wave range (e.g., higher than 20 Hz). The frequency is typically in the range from about 5 to 40 Hz, and is in the range from about 10 to 25 Hz in some preferred embodiments.

In embodiments in which each sonic source employed to perform the invention includes a sonic tube, the length and diameter of the sonic tube should ensure that sufficient sound energy is delivered into the reactor. Typically, the sonic tube length is in the range from about ⅛ to ⅜ times the sound wavelength (e.g., from about 3/16 to 5/16 times the sound wavelength in some preferred embodiments). If the sonic tube diameter is too small, part of the sound energy will be consumed within the sonic tube due to wall reflection. If the sonic tube diameter is too large, manufacturing and operating difficulties could be encountered. The sonic tube inner diameter employed in the present invention is typically from about 2 to 12 inches (e.g., from about 3 to 10 inches in some preferred embodiments).

Duration and interval of sound waves used for sonic cleaning are indices that determine sonic cleaner performance. “Duration” is the period of time (between consecutive “intervals”) in which a sonic source produces sound waves for sonic cleaning. “Interval” is the period of time between two consecutive activations of a sonic source. An excessively long interval can result in severe solid particle build-up on a reactor wall and cause difficulties in sonic cleaning of the wall. An excessively short duration may not achieve a sufficient cleaning effect. In typical embodiments of the invention, the interval of each sonic source is in the range from zero (i.e., continuous operation) to four hours. In some embodiments of the invention, a source operates intermittently with an interval (e.g., an interval of on the order of a few seconds or a few minutes) and a duration during one step of an operating cycle, and then is shut off entirely (or operated with reduced intensity) throughout another step (of the operating cycle) that may continue for a time longer than the interval (e.g., for a time in the range from a minute to four hours). The optimum “duration” of source operation in typical embodiments of the invention is typically at least 5 seconds (e.g., the duration is in the range from about 10 seconds to 60 seconds in some embodiments).

In a class of embodiments, operating parameters of each sonic source of a set of sonic sources are determined in accordance with the criterion set forth in equation (A) to improve reactor cleaning:

$$∯ {\sum }_{i = 1}^{N - 1} {\sum }_{j = 2}^{N} F ( {D}_{ij} ) ⅆ S = minimum ( i \neq j ) \qquad ( A )$$

where N is the total number of sonic sources, the integration is over the surface to be sonically cleaned (e.g., the freeboard surface of a reactor) at a time when at least one (but not necessarily all) of the sources operates to emit acoustic radiation, and F(Dᵢⱼ) is defined as F(Dᵢⱼ)=1, if Dᵢⱼ=(2m+½)W, and both the ith source and the jth source are operating, and F(Dᵢⱼ)=0, if Dᵢⱼ≠(2m+½)W, or either the ith source or the jth source is shut off, where m is a non-negative integer, acoustic waves emitted by the ith source and the jth source have wavelengths in a narrow range during cleaning of the surface, W is the wavelength of at least one acoustic wave emitted by at least one of the ith source and the jth source, and Dᵢⱼ is
Dᵢⱼ=|dᵢ−dⱼ|(i≠j)
where dᵢ and dⱼ are the distances from a spot to be cleaned on the surface to the ith and jth sonic source respectively. These distances represent both the direct route and reflective routes to the spot.

The criterion set forth in equation (A) can be applied at a sequence of different times, and operating parameters can be determined as a result of such multiple applications of the criterion. For example, each performance of the minimization can assume a different value of the wavelength W, or can assume that a different subset of a full set of sonic sources operates (e.g., where a sequence of different subsets of the full set are shut off while the other sources operate continuously or intermittently). The minimization can be performed multiple times to determine a sequence of operating parameter sets (e.g., a sequence that minimizes in some sense the combined results of all such minimizations). Operation of sonic sources whose operating parameters have been determined in accordance with the criterion of equation (A), e.g., by operating the sources in a sequence of different operating modes, can improve reactor cleaning in any of several different ways, including in one or more of the following ways: by eliminating or minimizing weak spots, by varying the locations of weak spots, and by reducing the time intervals during which weak spots occur at specific locations of the surface to be cleaned.

The surface integration in equation (A) assumes that the number (N) of sonic sources has been determined in advance. This determination can be made in any appropriate manner. In some cases, for example, the determination is made in the manner described in above-referenced U.S. Pat. No. 5,912,309. The surface integration in equation (A) also assumes that positions of the N sonic sources have been determined in advance, and orientations of the N sonic sources are determined (typically in advance) by other means. Positions and orientations of the sources can be determined in any appropriate manner. In some cases, for example, the sources are positioned as described in above-referenced U.S. Pat. No. 5,912,309, and a sonic nozzle of each source is oriented so that acoustic waves propagate directly from the sources to the entire surface to be cleaned, as described in above-referenced U.S. Pat. No. 5,912,309.

In a class of embodiments, the invention is a method for sonically cleaning a surface of a reactor using a set of sonic sources, said method including the steps of: (a) operating the set of sources in an initial operating mode to cause sonic waves incident on a surface of the reactor to produce a first set of weak spots on the surface of the reactor; and (b) after step (a), operating the set of sources in at least one other operating mode to cause sonic waves incident on the surface to produce a second set of weak spots on the surface that does not coincide with the first set of weak spots. In each individual one of the operating modes, each sonic source in the set operates with fixed frequency when active (but the frequencies of all the sonic sources are not necessarily the same), and each sonic source can operate either intermittently (e.g., can be sequentially shut off and on) or continuously (e.g., to emit sonic waves having constant or time-varying intensity) or can remain off (inactive).

In some embodiments in this class, the operating mode variation is accomplished in one of the following ways:

(1) sequentially shutting off different subsets of the set of sources and operating (either continuously or intermittently) each source that is not shut off;

(2) varying the intensity of acoustic waves emitted from at least one of the sources;

(3) varying the frequency of acoustic waves emitted from at least one of the sonic sources (e.g., within a small range about an optimal frequency);

(4) operating at least one of the sources (e.g., all of the sources) to emit acoustic waves having a sequence of different frequencies; and

(5) employing some sequence or combination of operations (1), (2), (3), and (4).

In typical embodiments, the inventive method achieves better cleaning performance than can be achieved by conventional sonic cleaning methods. In some preferred embodiments, the operation (1), (2), (3), (4), or (5) is performed with operating parameters determined in accordance with the criterion of equation (A). In some embodiments, a first subset of a set of sonic sources is operated to clean a reactor surface (each source in the first subset can either be operated continuously or intermittently during this step), and a second subset (different from the first subset) of the set of sonic sources is then operated to clean the reactor surface (each source in the second subset can either be operated continuously or intermittently during this step), and optionally also a third subset (different from each of the first subset and the second subset) of the set of sonic sources is then operated to clean the reactor surface (each source in the third subset can either be operated continuously or intermittently during this step).

When at least one source (of a set of sonic sources) is shut off during sonic cleaning of a reactor while the other sources are active, the incident sonic wave intensity vector at each location on the reactor wall is changed. Thus, former weak spots (at which wave cancellation took place before shut off) are no longer (after shut off) locations at which wave cancellation occurs and thus are no longer weak spots. During cleaning in accordance with the invention, it is preferred that a sufficient number of sonic sources emit acoustic waves during each time interval of the cleaning operation to prevent an intolerable decrease of overall reactor-cleaning performance. Typically, at least one sonic source emits (and preferably at least two sonic sources emit) acoustic waves during each time interval of a cleaning operation in accordance with the invention.

It should be understood that while some embodiments of the present invention are illustrated and described herein, the invention is not to be limited to the specific embodiments described and shown.

What is claimed is:

1. A method for sonically cleaning a surface of a reactor, including the steps of:
(a) operating a set of sonic sources in an initial operating mode to cause sonic waves incident on the surface of the reactor to produce a first set of weak spots on said surface; and
(b) after step (a), operating the set of sonic sources in at least one other operating mode to cause sonic waves incident on the surface to produce a second set of weak spots on the surface that does not coincide with the first set of weak spots.

2. The method of claim 1, wherein the reactor is a fluidized bed reactor having a freeboard surface during operation, and steps (a) and (b) are performed during operation of the reactor to clean the freeboard surface.

3. The method of claim 1, wherein the reactor is a fluidized bed reactor operable to perform polymerization, and steps (a) and (b) are performed to clean the surface while said reactor operates to perform polymerization.

4. The method of claim 1, wherein the reactor is a fluidized bed reactor operable to produce at least one polyolefin, and steps (a) and (b) are performed to clean a freeboard surface of the reactor while said reactor operates to produce said at least one polyolefin.

5. The method of claim 1, wherein during each individual operating mode, each sonic source operates with fixed frequency while active.

6. The method of claim 1, wherein operating parameters of each sonic source of the set in each said operating mode are determined in accordance with the criterion:
$$∯ {\sum }_{i = 1}^{N - 1} {\sum }_{j = 2}^{N} F ( {D}_{ij} ) ⅆ S = minimum , ( i \neq j )$$
where the integration is over the surface of the reactor at a time when at least one of the sources operates to emit acoustic radiation, and F(Dᵢⱼ) is defined as
F(Dᵢⱼ)=1, if Dᵢⱼ=(2m+½)W, and both the ith source and the jth source are operating, and
F(Dᵢⱼ)=0, if Dᵢⱼ≠(2m+½)W, or either the ith source or the jth source is shut off, where m is a non-negative integer, acoustic waves emitted by the ith source and the jth source have wavelengths in a narrow range during cleaning of the surface, W is the wavelength of at least one acoustic wave emitted by at least one of the ith source and the jth source, and
Dᵢⱼ=‥d₁−dⱼ|(i≠j)
where dᵢ and dⱼ are the distances from a spot to be cleaned on the surface to the ith and jth sonic source respectively.

7. A method for sonically cleaning a surface of a reactor by operating a set of sonic sources, including the step of: varying an operating mode of the set of sonic sources during sonic cleaning to reduce acoustic wave cancellation at at least some spots on a surface of the reactor, thereby cleaning the surface more effectively than if acoustic wave cancellation were not reduced by so varying the operating mode.

8. The method of claim 7, including the steps of:
sequentially shutting off different subsets of sonic sources of the set of sonic sources; and
operating each of the sonic sources that is not shut off.

9. The method of claim 7, including the steps of:
operating a first subset of the set of sonic sources to clean the surface; and then,
operating a second subset of the set of sonic sources to clean the surface, wherein the second subset of the set of sonic sources is different than the first subset of the set of sonic sources.

10. The method of claim 7, including the step of: varying the intensity of acoustic waves emitted from at least one of the sonic sources.

11. The method of claim 7, including the step of: varying the frequency of acoustic waves emitted from at least one of the sonic sources.

12. The method of claim 7, including the step of: operating at least one of the sonic sources to emit acoustic waves having a sequence of different frequencies.

13. The method of claim 7, wherein the variation of the operating mode of the set of sonic sources prevents occurrence of at least one weak spot on the surface.

14. The method of claim 7, wherein the variation of the operating mode of the set of sonic sources reduces the number of weak spots on the surface.

15. The method of claim 7, wherein the variation of the operating mode of the set of sonic sources reduces the size of at least one weak spot on the surface.

16. The method of claim 7, wherein the variation of the operating mode of the set of sonic sources changes locations of weak spots on the surface.

17. The method of claim 7, wherein the variation of the operating mode of the set of sonic sources reduces time durations during which weak spots occur at specific locations on the surface.

18. The method of claim 7, also including the steps of:
(a) determining a position, relative to the reactor, of each sonic source of the set of sonic sources;
(b) positioning said each sonic source in the position determined in step (a); and
(c) after step (b), sonically cleaning the surface of the reactor including by varying the operating mode of the set of sonic sources to reduce acoustic wave cancellation at said at least some spots on the surface.

19. The method of claim 7, wherein operating parameters of each sonic source of the set are determined in accordance with the criterion:
$$∯ {\sum }_{i = 1}^{N - 1} {\sum }_{j = 2}^{N} F ( {D}_{ij} ) ⅆ S = minimum , ( i \neq j )$$
where the integration is over the surface of the reactor at a time when at least one said source operates to emit acoustic radiation, and F(Dᵢⱼ) is defined as
F(Dᵢⱼ)=1, if Dᵢⱼ=(2m+½)W, and both the ith source and the jth source are operating, and
F(Dᵢⱼ)=0, if Dᵢⱼ=(2m+½)W, or either the ith source or the jth source is shut off,
where m is a non-negative integer, acoustic waves emitted by the ith source and the jth source have wavelengths in a narrow range during cleaning of the surface, W is the wavelength of at least one acoustic wave emitted by at least one of the ith source and the jth source, and
Dᵢⱼ=|dᵢ−dⱼ|(i≠j)
where dᵢ and dⱼ are the distances from a spot to be cleaned on the surface to the ith and jth sonic source respectively.

20. A method for determining a position, and operating parameters, of each sonic source of a set of sonic sources to be used for sonically cleaning a surface of a reactor, said method including the steps of:
(a) determining a total number, N, of sonic sources in the set, and a position relative to the reactor of each sonic source in the set; and
(b) determining operating parameters of each sonic source of the set in accordance with the criterion:
$$∯ {\sum }_{i = 1}^{N - 1} {\sum }_{j = 2}^{N} F ( {D}_{ij} ) ⅆ S = minimum , ( i \neq j )$$
where the integration is over the surface at a time when at least one of the sources operates to emit acoustic radiation, and F(Dᵢⱼ) is defined as
F(Dᵢⱼ)=1, if Dᵢⱼ=(2m+½)W, and both the ith source and the jth source are operating, and
F(Dᵢⱼ)=0, if Dᵢⱼ≠(2m+½)W, or either the ith source or the jth source is shut off,
where m is a non-negative integer, acoustic waves emitted by the ith source and the jth source have wavelengths in a narrow range during cleaning of the surface, W is the wavelength of at least one acoustic wave emitted by at least one of the ith source and the jth source, and
Dᵢⱼ=|dᵢ−dⱼ|(i≠j)
where dᵢ and dⱼ are the distances from a spot to be cleaned on the surface to the ith and jth sonic source respectively.

21. The method of claim 20, wherein the operating parameters determined in step (b) include duty cycle and output acoustic wave frequency at each instant during sonic cleaning of the surface.

22. The method of claim 20, wherein the operating parameters determined in step (b) specify that the set of sonic sources is operated in an initial operating mode, and is then operated in at least one other operating mode during sonic cleaning of the surface.
